(19) United States
(12) Patent Application Publication
(10) Pub. No.: US 2005/0132124 A1
(43) Pub. Date: Jun. 16, 2005

(54) [SILICON STORAGE APPARATUS, CONTROLLER AND DATA TRANSMISSION METHOD THEREOF]

(76) Inventor: Hsiang-An Hsieh, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,308

(22) Filed: Apr. 28, 2004

(30) Foreign Application Priority Data
Dec. 11, 2003 (TW) 92134969

(51) Int. Cl. G06F 12/00

(52) U.S. Cl. 711/103; 711/137

(57) ABSTRACT

A silicon storage apparatus, a controller and a data transmission method thereof are disclosed. The storage apparatus comprises a solid-state storage medium and a controller. The controller further comprises a system interface, a memory interface, a processor, a cache buffer area, an allocation buffer area and a transmission buffer. By the cooperation of the cache and the allocation table buffer area, the data not required by the system terminal are stored in the solid-state storage medium for improving the cache request hit rate. Therefore, the times of searching the solid-state storage medium is reduced and the transmission performance is increased.

### CROSS REFERENCE TO RELATED APPLICATIONS

This application claims the priority benefit of Taiwan application serial no. 92134969, filed Dec. 11, 2003.

### BACKGROUND OF INVENTION

1. Field of the Invention

The present invention relates to a silicon storage apparatus, and more particularly to a silicon storage apparatus, a controller and a data transmission method thereof.

2. Description of Related Art

Because of the advancement of technology, the silicon storage media includes: flash memory cards and memory sticks. Compared with the floppies and compact disks, they have the following advantages: portability, low power consumption, data maintenance, data transmission speed, multiple read/write, shockproof and waterproof. Therefore, flash memory cards and memory sticks have been replacing the traditional storage media.

Usually, the flash memory cards and memory sticks are composed of controllers and solid-state storage media. FIG. 1 is a functional block diagram showing a prior art silicon storage apparatus. The silicon storage apparatus 100 comprises: a controller 110 and a solid-state storage medium 120. The controller 110 comprises: a system interface 112 coupled to an external system 150, a processor 140 adapted to process system signals and a memory interface 116 coupled to the solid-state storage medium 120. The data to be stored on the system terminal 150 can be written into the solid-state storage medium 120, and the stored data can be accessed from the solid-state storage medium 120.

With the advancement of technology, the data transmission speed of the system terminal 150 is greatly enhanced which results in the increase of the difference between the transmission speed system terminal and the storage apparatus 100. Because of the difference, the system terminal is idle when the storage apparatus 100 is in operation mode. Therefore, the delay of data transmission occurs. For example, when the system is under read mode, the stand-by time of the system terminal 150 includes the seek time of the storage medium 120 and the upload time. When the system is in write mode, the stand-by time of the system terminal 150 includes download time and the update time of the storage medium 120, which comprises the programming time and the erasing time.

In order to resolve the issue of the stand-by time of the system terminal 150, the prior art method uses a transmission buffer 118 between the system terminal 150 and the memory interface 116 for temporarily storing the data required by the system terminal 150. Therefore, the system terminal 150 can search the sector data stored in the solid-state storage medium 120 without waiting for the process of the processor 114 under read operation.

In write operation, because the read/write speed of the transmission buffer 118 is higher than that of the solid-state storage medium 120, the transmission buffer 118 can temporarily stores the data therein in response to the write signal from the system terminal 150. Therefore, the stand-by time of the system terminal 150 responding to the storage apparatus 100 is reduced. The read/write speed between the storage apparatus 100 and the system terminal 150 is improved by enhancing the transmission speed of the system terminal 150. For example, the transmission speed of the 1.1 version of USB interface is 12 Mbps; the speed of the upgraded 2.0 version is 480 Mbps. Because of the improvement of the transmission speed, the upload time and download time on the system terminal 150 can be reduced.

Although the stand-by time on the system terminal 150 can be reduced by the use of the transmission buffer 118 and the improvement of the system terminal 150, the d transmission speed still can not be increased to a desired level because the transmission buffer 118 cannot input and output data simultaneously. Accordingly, the buffer time of the storage apparatus 100 is increased. In other words, when the storage apparatus 100 is in operation mode, an additional execution time is required, resulting from the reason that the transmission buffer 118 does not output data until the data are completely received. Although the system terminal 150 is in normal operation without waiting the buffer operation, the additional buffer time of the storage apparatus 100 is unavoidable.

Therefore, two transmission buffers are set between the system interface 112 and the memory interface 116. When a transmission buffer is in receiving operation, the other one is in transmission operation. Accordingly, the buffer time of the storage apparatus 100 is avoided.

Although the use of the two transmission buffers can resolved the issue of the buffer time, the seek time on the storage apparatus 100 is not avoidable because the transmission buffer 118 operates according to the read signal from the system terminal 150. In other words, the prior art apparatus cannot effectively reduce the buffer time of the storage apparatus 100.

In addition, the capacity of the transmission buffer 118 is small. For the data stored in the system terminal 150 in cluster having at least eight sectors and 4K bytes, the transmission buffer 118 can store only one sector or two sectors data which does not meet the requirement of the system terminal 150. When the system terminal 150 reads a cluster of data, the storage apparatus 100 should execute N times of read/write operations. Even though the solid-state storage medium 120 has a huge capacity, such as billions of bytes, 1K-2K bytes data are going to respond with the read signal transmitted from the system terminal 112 by the storage apparatus 100. Accordingly, the system terminal 150 should output many times of read signals to access the data stored in the storage apparatus 100. It increases not only the frequency of the termination of the system terminal, but also the times of the read/write.

The similar problem also arises at the system terminal under write operation. When the write signal is transmitted to the storage apparatus, the transmission buffer temporarily stores the decoding signal/address and the reference data, such as the file allocation table (FAT). Because of the small capacity of the transmission buffer, the data to be written into the solid-state medium cannot be stored therein until the processor receives the decoding signal/address, the reference data are stored in the solid-state storage medium and the transmission buffer is clear.

From the descriptions above, the prior art silicon storage apparatus has following disadvantages:1. Because of the small capacity of the transmission buffer, the read/write should be performed several times. The multiple read/write operations increase not only the frequency of termination of the storage apparatus, but also the frequency of read/write operations thereof. 2. Because the data temporarily stored depends on the signal of the system terminal, the buffer time of the storage apparatus cannot be effectively reduced.

### SUMMARY OF INVENTION

Accordingly, the present invention is related to a silicon storage apparatus, a controller and a data transmission method thereof. By reducing the stand-by mode of the system, the data transmission speed between the system terminal and the storage apparatus can be effectively enhanced.

According to an embodiment of the present invention, the read and seek frequencies of the system terminal and the storage apparatus respectively are reduced by extending the temporary capacity of the internal buffer area and specifying the controlling procedure, such as pre-read function.

According to an embodiment of the present invention, while executing writing, the system terminal transmits the write data and the waiting data so that the system terminal can undergo with other operations.

According to an embodiment of the present invention, the context of the reference data, such as the file allocation table, can be renewed without the generation of the write data so as to reduce the renewal frequency of the writing step of the storage apparatus for improving the performance of the system terminal and the storage apparatus.

In an embodiment of the present invention, the silicon storage apparatus comprises a solid-state storage medium and a controller. The solid-state storage medium is adapted for storing a plurality of data. The controller is coupled to the solid-state storage medium, wherein when the controller receives a read signal, the controller stores a portion of the data therein which are not required by the read signal.

In an embodiment of the present invention, the controller of the silicon storage apparatus comprises a processor, a system interface, a memory interface, a transmission buffer and a cache buffer. The system interface is adapted for receiving an operation signal. The memory interface is coupled to a solid-state storage medium. The transmission buffer is coupled to the processor, the memory interface and the system interface. The cache buffer is coupled to the memory interface and the system interface. When the operation signal is a read signal, the processor refers to a address mapping table so as to store a pre-storage data which is not indicated by the read signal in the cache buffer; when the system interface receives a subsequent read signal of the read signal, the processor compares the pre-storage data and the subsequent read signal of the read signal and determines whether they are matched.

According to an embodiment of the present invention, a data transmission method of the controller of the silicon storage apparatus is provided. According to this method, a first data required by a read signal is received by the transmission buffer. Next, a second data not indicated by the read signal is stored by the cache buffer after the transmission buffer is saturated. Finally, whether the second data matches with a third data is determined in response to a subsequent read signal of the read signal.

In an embodiment of the present invention, when the system accesses the storage apparatus, the controller stores the data not required by the system in the cache buffer. After the process compares and determines that the data of the subsequent read signal and the temporarily stored data matches with each other, the sector data are extracted from the cache buffer and outputted from the system interface.

In another embodiment of the present invention, when the system writes the data into the storage medium, it transmits the write signal to the transmission area while transmitting the data written in the solid-state medium to the cache buffer for temporary storage. Accordingly, after the processor decodes the signal, the data temporarily stored in the cache buffer can be written into the solid-state storage medium so that the system can perform other operations.

In an embodiment of the present invention, an allocation table buffer area is set between the system interface and the memory interface. When the data read by the system terminal are not continuous, the discontinuous data not indicated by the system terminal are pre-stored in the cache buffer according to the address mapping table. Therefore, the cache request hit rate is enhanced, and the seek frequency of the solid-state storage medium is reduced.

In the embodiments above, when the system is in write state, the context of the write signal renewal reference table is temporarily stored in the high-speed allocation table buffer area. When the storage operation of the system is completed, the context of the address mapping table in the allocation table buffer area is written into the solid-state storage medium. Therefore, the time consuming step of storing the context of the address mapping table into the solid-state medium can be avoided so as to reduce the renewal time for the non-write data of the storage apparatus.

In one embodiment of the present invention, the cache buffer comprises at least one minimum accessing unit, such as cluster, as the storage unit corresponding to the read/write of the system terminal for reducing the read/write frequency resulting from the low capacity of the system terminal.

Accordingly, the data stored in the solid-state medium is pre-stored in order to reduce the seek frequency of the solid-state storage medium by the processor and to enhance the performance of the data transmission. Moreover, the cache request hit rate is increased by the corporation of the cache buffer and the allocation table buffer area. Additionally, the use of the allocation table buffer area can reduce the number of read/write operations of the solid-state storage medium so as to increase the data read/write speed. Finally, the present invention also increases the capacity of the cache buffer. The number of read/write can be reduced while transmitting the files, and the frequency of the storage apparatus is also reduced. Accordingly, the present invention can be practically and advantageously applied to memory cards for replacing floppies and compact disks.

In order to make the aforementioned and other objects, features and advantages of the present invention understandable, a preferred embodiment accompanied with figures is described in detail below.

### BRIEF DESCRIPTION OF DRAWINGS

FIG. 1 is a block diagram showing a conventional silicon storage apparatus.

FIG. 2 is a block diagram showing a silicon storage apparatus according to one embodiment of the present invention.

FIGS. 3A-3C are schematic drawings showing the read/write operation of the silicon storage apparatus according an embodiment of the present invention.

FIG. 3D is a flow chart showing a data transmission method of a controller of a silicon storage apparatus according to an embodiment of the present invention.

FIGS. 4A and 4B are a schematic configuration showing the write operation of the silicon storage apparatus according to an embodiment of the present invention.

FIG. 5 is a block diagram showing a silicon storage apparatus according to another embodiment of the present invention.

FIGS. 6A-6C are schematic configurations showing a read operation of the silicon storage apparatus according to another embodiment of the present invention.

FIGS. 7A and 7B are schematic configurations showing a write operation of the silicon storage apparatus according to another embodiment of the present invention.

FIG. 8 is a figure showing a high-speed file allocation connection table according to an embodiment of the present invention.

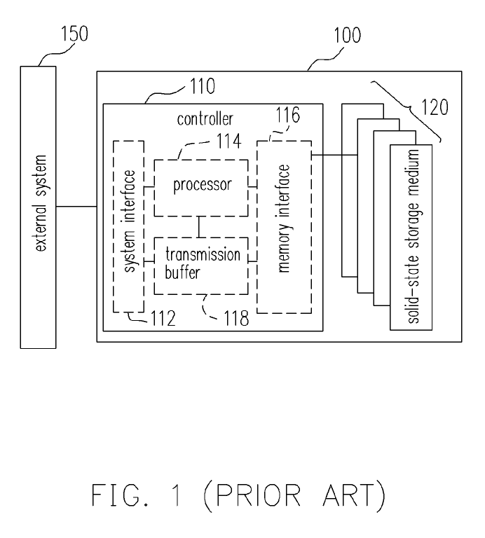

### DETAILED DESCRIPTION

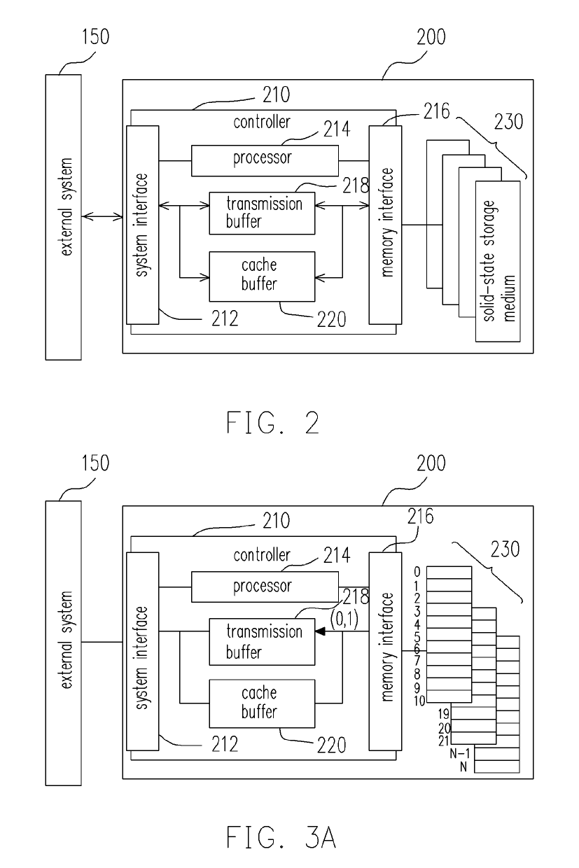

FIG. 2 is a block diagram showing a silicon storage apparatus according to an embodiment of the present invention. Referring to FIG. 2, the silicon storage apparatus 200 comprises a solid-state storage medium 230 and a controller 210. The controller 210 comprises a system interface 212, a memory card 216, a processor 214, a cache buffer 220 and a transmission buffer 218.

The controller 210 is coupled to the solid-state storage medium 230. In addition, the processor 240 is coupled to the system interface 212 and the memory interface 216. The transmission buffer 218 is coupled to the processor 214, the memory interface 216, the system interface 212 and the cache buffer 220. The system interface 212 is coupled to the external system 150, such as external or internal card readers, and transfer cards.

In the embodiment of the present invention, the solid-state storage medium 230 comprises a plurality of sectors having 512 bytes, and is adapted for storing data. Each sector is adapted for store a sector data. The transmission buffer 218 is adapted to temporarily store a system signal transmitted from the system terminal 150 and the sector data in response thereto. The capacity of the transmission buffer 218 is set as 1K bytes, i.e. two sector data. Moreover, the cache buffer 220 is adapted for storing a pre-storage data. In order to match with the file storage of the system terminal 150, the capacity of the cache buffer 220 is more than one fold that of the transmission buffer 218. In other words, the cache buffer 220 comprises a plurality of minimum accessing unit, such as cluster.

In an embodiment of the present invention, the cache buffer 220 and the transmission buffer 218 are used together, and the input and output of the data between the system interface 212 and the memory interface 216 are alternately synchronized so that the buffer time for temporarily storing data in transmission buffer 218 can be reduced or avoided.

For example, the data accessed by the external system 150 continuously exit in sector address in the solid-state storage medium 230, or stored in the sector data of the discontinuous sectors belonging to the same file. When the silicon storage apparatus 200 is in read state, i.e., the silicon storage apparatus 200 provides data to the external system 150, the pre-stored sector data of the cache buffer 220 are mainly these two types of sector data above. Because the cache buffer 220 of the present invention provides the function of pre-storage of the sector data, the silicon storage apparatus 200 not only has the normal read/write mode, but also the cache read/write mode.

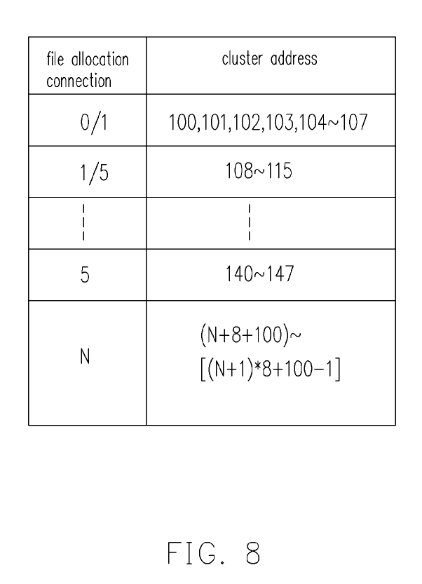

Under cache read/write mode, the controller 210 can determine the sector data to be pre-stored in the cache buffer 220, if the cache buffer 220 just stores the continuous sector data indicated by the solid-state storage medium 230 and the external system 150. However, if the sector data to be pre-stored by the cache buffer 220 are discontinuously stored in the sector data, the storage should refer to the file allocation table (FAT) and the data storage reference table as shown in FIG. 8.

The cache buffer 220 stores the sector data required by a subsequent signal by the external system 150. Under the cache read/write mode, if the external system 150 sends the subsequent signal to the silicon storage apparatus 200, and the controller 210 determines that the sector data pre-stored by the cache buffer 220 is response thereto, the controller 210 uploads the pre-stored sector data in the cache buffer 220 directly to the external system 150 without seeking the data from the solid-state storage medium 230.

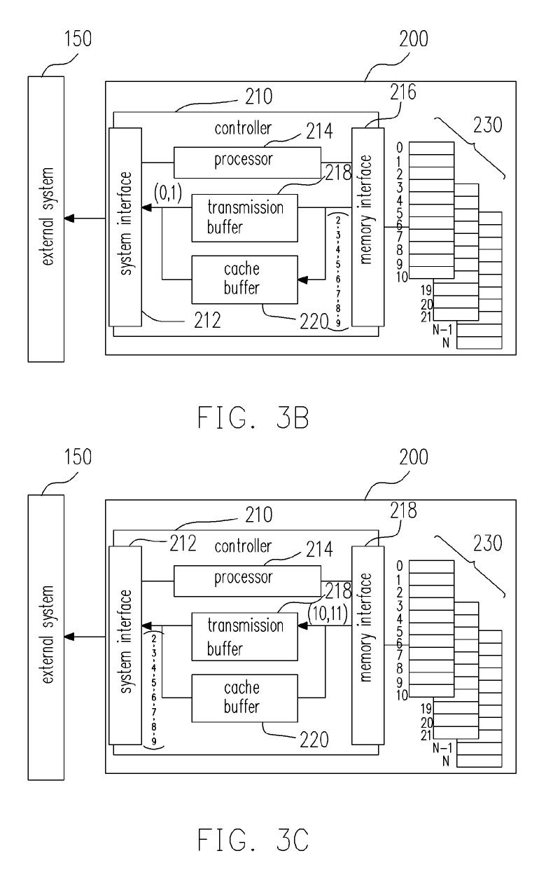

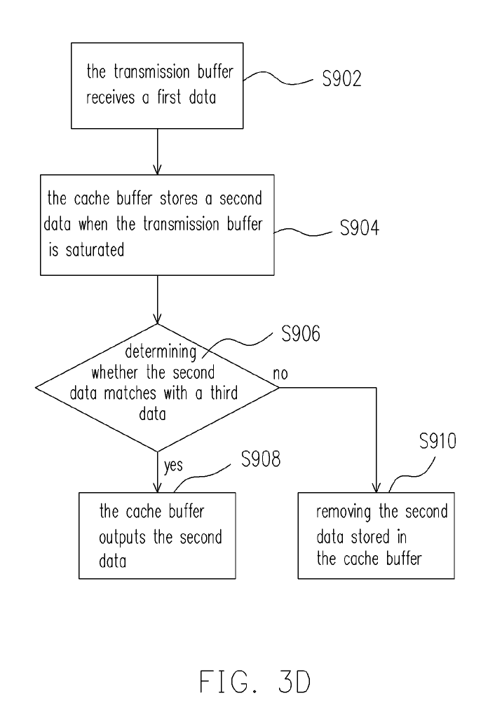

FIGS. 3A-3C are schematic drawings showing the read/write operation of the first silicon storage apparatus. Referring to 3A, when the processor 214 of the storage apparatus 200 receives the first system signal R (0,1), the read signal R and the address (0,1) are obtained by decoding process. The solid-state storage medium 220 seeks the sector address in response thereto, accesses the sector data and temporarily stores the sector data in the transmission buffer 218.

Referring to FIG. 3B, the transmission buffer 218 just read two sector data. After the data in response to the first system signal is stored, the transmission buffer 218 is going to be saturated. The processor 214 uploads the sector data of the transmission buffer 218 to the system terminal 150. Meanwhile, the processor 214 can write the continuous sector data corresponding to the subsequent sector data after the sector 1 into the cache buffer 220. Because the capacity of the cache buffer 220 is eight sectors, the subsequent sectors 2-9 can be pre-stored in the cache buffer 220.

Referring to FIG. 3C, when the external system 150 transmits the system signal, the processor 214 decodes and transforms the signal. When a portion, or all, of the data sectors match therewith, the processor 214 accesses and uploads the sector data from the system interface 212 to the external system 150.

According to the embodiment, the processor 214 uses the continuous sector data to determine the sector data in the cache buffer 220. As the description mentioned above, the process can also use the sector data belonging to the same file to predict the sector data. Referring to FIG. 8, the context of the address mapping table comprises the allocation connection parts 0, 1, and 5. Addresses corresponding to the file parts include the clusters 100-107, 108-115 and 140-147. With respect to the processor 214 adopting the sector data belonging to the same file, the initial data transmission is similar to that of the continuous sector data. Once the cluster 115 having eight continuous sector data is transmitted to the external system 150, the processor 214 actively accesses the allocation connection part 5 according to the address mapping table. It means that the third part of the file is saved. The processor 214 also acquires the sector data responding with cluster 140. The data are stored in transmission buffer 218 or the cache buffer 220.

According to the read/write mode above, the time and frequency for data search of the silicon storage apparatus 200 is reduced. With respect to the external system 150, the data search and the data transmission of the silicon storage apparatus 200 can be performed simultaneously. Accordingly, the time for waiting the data can be substantially reduced, and the operation speed is enhanced. In the prediction mechanisms described above, they can help the processor 214 to predict the sector data required by the subsequent read signal, and the cache request hit rate is substantially increased. It should be noted that once the sector data required by the subsequent read signal does not match with the sector data pre-stored by the cache buffer 220, or the subsequent signal is a write signal, the processor 214 removes the sector data pre-stored by the cache buffer 220.

FIG. 3D is a flow chart showing a data transmission method of a controller of a silicon storage apparatus according to an embodiment of the present invention. For the purpose of interpretation, the elements in FIG. 3D have the number as same as those in FIG. 3A.

In the embodiment, the transmission buffer 218 receives the first data, i.e., 0 and 1, required by the read signal shown in step S902 from the solid-state storage medium 230. The read signal is received by the system interface 212. The processor 214 seeks and transmits the first data from the solid-state storage medium 230 to the transmission buffer 218.

After the transmission buffer 218 is saturated, the processor 214 not only controls the system interface 212, transmitting the first data stored in the transmission buffer 218 to the external system 150, but also pre-stores the second data not required by the read signal as the sectors 2-9 shown in FIG. 3B. Moreover, it also stores the second data in the cache buffer 220 in step S904. The step S906 determines whether the second data matches with the third data required by the subsequent read signal following the read signal. If they do, the second data stored in the cache buffer 220 is transmitted from the system interface 212 to the external system 150 in step S908. If they do not, the sector data pre-stored in the cache buffer 220 is removed in step S910.

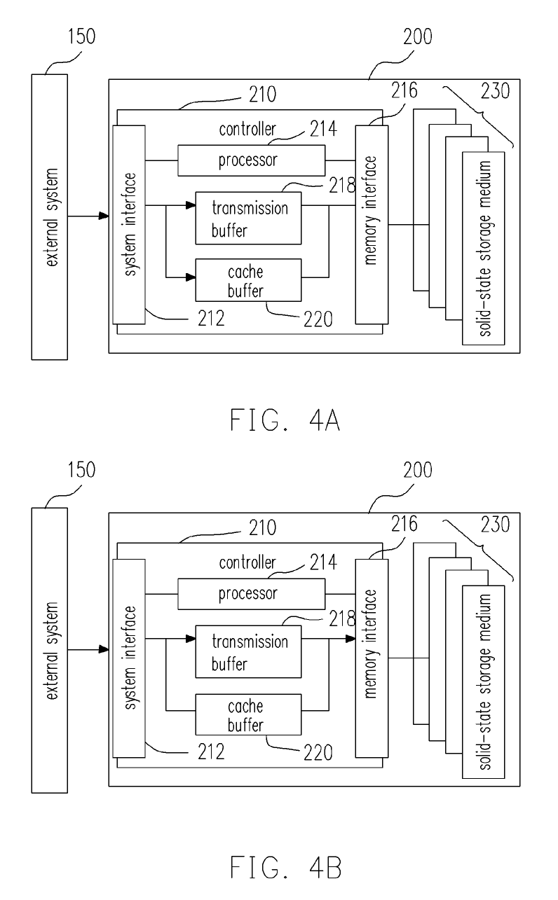

FIGS. 4A and 4B are a schematic configuration showing the write operation of the first embodiment of the silicon storage apparatus. Referring FIG. 4A, when the transmission buffer 218 receives the write signal from the external system 150, and the processor acquires the system signal from the transmission buffer 218 for decoding, the cache buffer 220 simultaneously receives the sector data to be written from the external system 150.

Referring to FIG. 4B, after the decoding process is complete, the temporarily stored sector data in the cache buffer 220 are written in the solid-state storage medium 230 through the memory interface 216. Because the capacity of the cache buffer 220 can accommodate at least one cluster, a large data can be written in the solid-state storage medium 230. In addition, while the data stored in the cache buffer 220 are transmitted to the solid-state storage medium 230 through the memory interface 216, the transmission buffer 218 keeps on receiving the sector data transmitted from the external system 150 for reducing terminating the external system 150 and obtaining the desired data transmission frequency and time.

When the write operation is executed, not only the sector data to be written is being written into the solid-state storage medium 230, but also the address mapping table or the file allocation table corresponding to the sector data, which is stored in the solid-state storage medium 230 should be renewed. Moreover, in prior art, the procedure to obtain the actual address by referring the address mapping table is required, and therefore the data transmission is subject to delay.

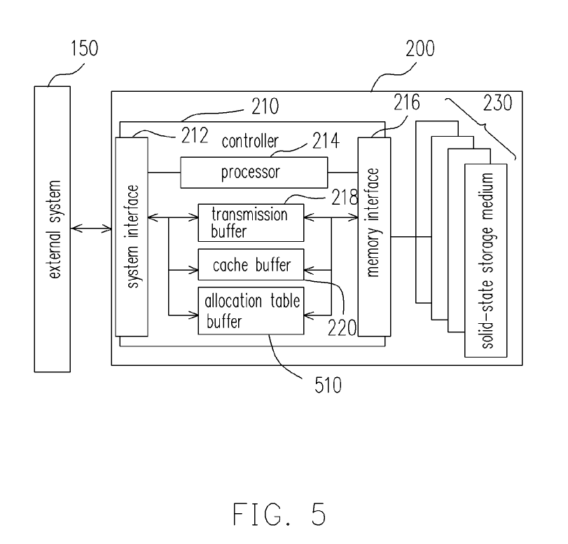

To resolve the above issue, the address mapping table is stored in the high-speed read/write memory for reducing the frequency of storing the data in the solid-state storage medium 230. FIG. 5 is a block diagram showing a silicon storage apparatus according to another embodiment of the present invention. In order to reduce the frequency of renewing the data storage in the solid-state storage medium 230, the present invention uses an allocation table buffer area 510, which is adapted to store the FTA or the address mapping table in FIG. 8, between the system interface 212 and the memory interface 216. The address mapping table comprises the reference between the cluster logic address and the sector address of the solid-state storage medium 230 of the silicon storage apparatus 200.

Through the allocation table buffer area 510, the context of the address mapping table can be partially modified, then stored in the solid-state storage medium 230 when the silicon storage apparatus is idle. Accordingly, the frequency of the read/write of the solid-state storage medium 230 can be reduced. Moreover, because only the context of the allocation table buffer area 510 should be referred, the actual address of the memory can be quickly accessed. Therefore, the frequency of read/write operation of the solid-state storage medium 230 referring to the address mapping table can be reduced.

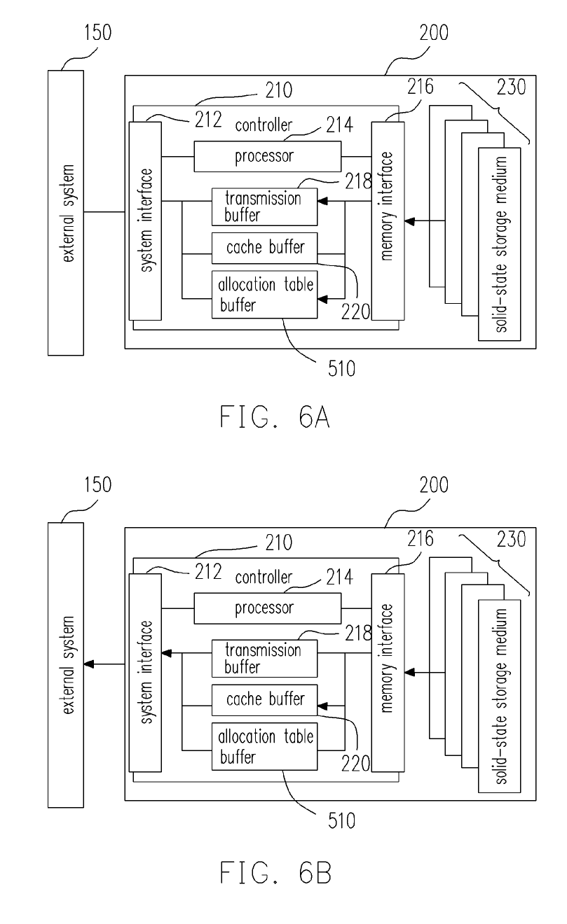

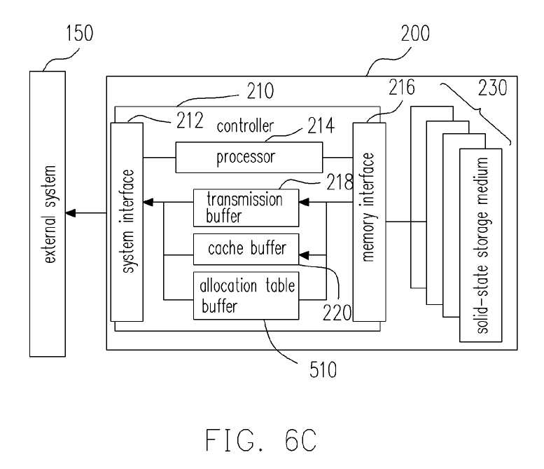

FIGS. 6A-6C are schematic configurations showing a read operation of the silicon storage apparatus according to an embodiment of the present invention. Referring to FIGS. 6A-6C, the cache mode cooperates with the allocation table buffer area 510. The file of the embodiment comprises the file allocation connection 0 with cluster addresses 100-107, the file allocation connection 1 with cluster addresses 108-115 and the file allocation connection 5 with cluster addresses 140-147.

Referring to 6A, before the external system 150 accesses the files stored in the solid-state storage medium 230, the processor 214 of the silicon storage apparatus 200 copies a copy of the address mapping table which is then stored in the allocation table buffer area 510. According to the read signal of the external system 150, the sector data of the cluster address 100 of the file allocation connection 0 are extracted from the solid-state storage medium 230 and temporarily stored in the transmission buffer 218. Due to the shortage of the capacity of the transmission buffer 218, only two sector data of the cluster address 100 are stored therein.

Referring to FIG. 6B, when the transmission buffer 218 is saturated, the sector data is uploaded. Meanwhile, the processor 214 accesses the other six sector data of the cluster address 100 required by the external system 150, which are then stored in the cache buffer 220. When the cache buffer 220 is still available, two sector data of the cluster address 101, which are not required by the read signal, are pre-stored therein.

Referring FIG. 6C, when the external system 150 reads the remaining sector data, the processor 214 outputs the sector data of the transmission buffer 218 and the six sector data of the cluster address 100 stored in the cache buffer 220 to the external system 150. After the external system 150 completes the receiving and operation steps of the cluster data 100, the other read signal can be sent thereto. If the sector data address matches with the data pre-stored in the cache buffer 220, the processor 214 can directly upload the two sector data of the cluster address 101 pre-stored in the buffer area 220.

When the cache buffer 220 is uploading the data, the transmission buffer 218 receives the subsequent sector data not stored in the cache buffer 220. For example, when the cache buffer 220 stores just two sector data of the address cluster 101 and uploads the sector data, the transmission buffer receives the subsequent sector data of the cluster address 101. Accordingly, once the data stored in the cache buffer 220 are clear, the system receives the subsequent sector data from the transmission buffer 218.

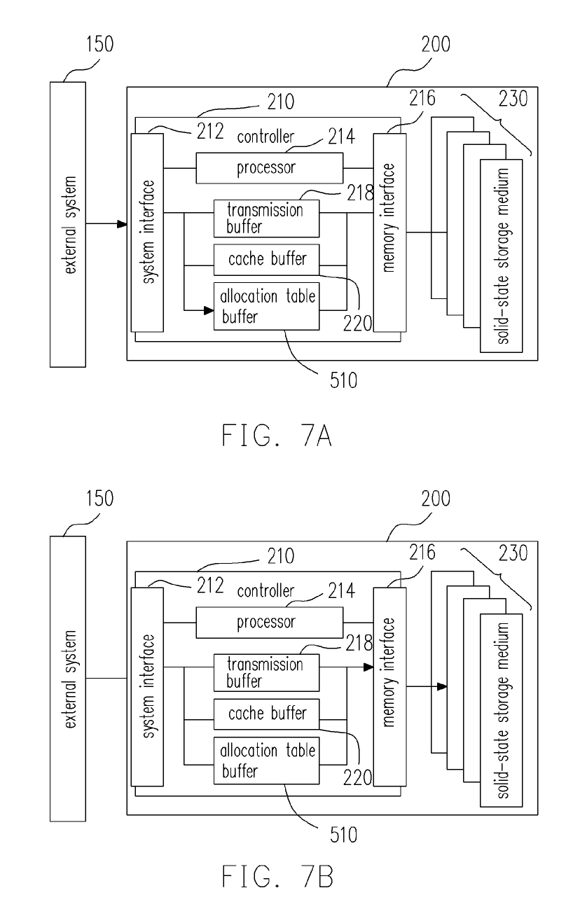

FIGS. 7A and 7B are schematic configurations showing a write operation of the silicon storage apparatus according to an embodiment of the present invention. Referring to FIG. 7A, when the transmission buffer 218 receives the write signal from the external system 150 and the processor 214 decodes the signal, the context of the reference table in the allocation table buffer area 510 is renewed according to the transmission of the write signal. Therefore, the sector data to be written can be written into the solid-state storage medium 230 through the memory interface 216 after the processor 214 completes decoding the signal. However, the context of the reference table is not written into the solid-state storage medium 230 until the write operation of the external system 150 is completed. Then the renewed context of the reference table in the allocation table buffer area 510 is stored in the solid-state storage medium 230 shown in FIG. 7B so that the frequency of renewing the context of the reference table can be reduced.

From the descriptions above, because the present invention pre-stores the data not required by the solid-state storage medium, the times of searching the solid-state storage medium are reduced and the data transmission is improved. Moreover, the cooperation of the cache buffer and the allocation table buffer area enhances the cache request hit rate, and reduces the read/write of the solid-state storage medium. Therefore, the speed of the data transmission is enhanced. Moreover, the increase of the capacity of the cache buffer reduces the read/write of the transmission file and the possibility of terminating the system terminal.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. A silicon storage apparatus, comprising:
a solid-state storage medium, adapted for storing a plurality of data; and
a controller, coupled to said solid-state storage medium;
wherein said controller receives a read signal to pre-store a portion of the data therein which are other of said data required by the read signal.

2. A controller of a silicon storage apparatus, comprising:
a processor;
a system interface, adapted for receiving an operation signal;
a memory interface, coupled to a solid-state storage medium;
a transmission buffer, coupled to said memory interface and said system interface; and
a cache buffer, overlapping said transmission buffer to couple to said memory interface and said system interface;
wherein when said operative signal is a read signal, said processor retrieves a address mapping table to store a pre-storage data which is not indicated by said read signal intosaid cache buffer; and when said operative signal is a subsequent read signal, saidcache buffer stores a data, and said processor determines whether or not said data conform to said pre-storage data.

3. The controller of a silicon storage apparatus as cited in claim 2, further comprising an allocation table buffer area, coupling to said system interface and said memory interface, adapted to store said address mapping table.

4. The controller of a silicon storage apparatus as cited in claim 2, wherein said cache buffer and said transmission buffer alternately synchronously transmit data.

5. A data transmission method of a controller of a silicon storage apparatus, said silicon storage apparatus comprising a transmission buffer, a cache buffer, an allocation table buffer area, a system interface and a memory interface, said method comprising:
receiving a first data required by a read signal by said transmission buffer;
storing a second data not indicated by the read signal intosaid cache buffer after the transmission buffer being saturated; and
comparing and determining whether said second data conform to a third data required requested by a subsequent read signal.

6. The data transmission method of a controller of a silicon storage apparatus as cited in claim 5, wherein the step of determining whether said second data conform tosaid third data required by said subsequent read signal, further comprises:
outputting said second data from said cache buffer when said second data conform tosaid third data; and
removing said second data from said cache buffer when said second data does not conform to the third data.

7. The data transmission method of a controller of a silicon storage apparatus as cited in claim 5, wherein the cache buffer comprises at least one minimum accessing unit, and said minimum accessing unit comprises at least one sector.

8. The data transmission method of a controller of a silicon storage apparatus as cited in claim 5, wherein the cache buffer and the transmission buffer alternately synchronously transmit data.

9. The data transmission method of a controller of a silicon storage apparatus as cited in claim 5, wherein when said system interface receives a write signal and a write data in response thereto, said processor writes said write data into a solid-state medium according to a address mapping table; and when the process for writing data is completed, said address mapping table is written into said solid-state medium.

10. The data transmission method of a controller of a silicon storage apparatus as cited in claim 9, wherein said cache buffer receives said write data transmitted from said system interface while said processor is decoding said write data signal; and when the process of said decoding is completed, said write data is written into said solid-state medium from said cache buffer through said memory interface.

11. The data transmission method of a controller of a silicon storage apparatus as cited in claim 9, wherein the content of said address mapping table is renewed according to the transmission of said write signal; said processor writes said write data into said solid-state storage medium from said cache buffer through said memory interface; and when the process of said writing is completed, said address mapping table is written into said solid-state medium.
